(19) United States
(12) Patent Application Publication
(10) Pub. No.: US 2009/0193837 A1
(43) Pub. Date: Aug. 6, 2009

(54) Insulating Apparatus with Removable Thermal Adjustment Units

(76) Inventor: Gregory Hamlin, Northridge, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/331,209

(22) Filed: Dec. 9, 2008

Related U.S. Application Data
(63) Continuation-in-part of application No. 12/023,846, filed on Jan. 31, 2008.

(51) Int. Cl. F25D 3/00; B65D 81/38; B23P 19/04

(52) U.S. Cl. 62/457.5; 220/592.2; 29/700

(57) ABSTRACT

A cooler apparatus including removable thermal adjustment units is described. In one embodiment, the cooler apparatus comprises a housing defining an outer wall including a side wall and a bottom wall, an inner wall and a plurality of compartments between the inner wall and outer wall, the inner wall defining a storage compartment. A thermal adjustment unit is then removably coupled to the housing and fit within one of the plurality of compartments to adjust a temperature. In this manner, an interior temperature of the cooler may be adjusted. A removable tray may be included in the cooler. The removable tray may define a set of receptacles for receiving a set of items, including beverages. A lid may then be coupled to another removable thermal adjustment unit. The lid is attached to an open portion of the cooler to form a seal for preserving the interior temperature of the cooler. A handle and a set of wheels are then coupled to the exterior of the cooler to facilitate transportation of the cooler.

### CROSS-REFERENCE TO RELATED APPLICATION

The present patent application is a Continuation-In-Part of application Ser. No. 12/023,846, filed Jan. 31, 2008.

### FIELD OF THE INVENTION

Embodiments of the present invention relate to an insulating apparatus and a process for manufacturing the insulating apparatus. Specifically, the embodiments of the present invention include a cooler or warmer with removable thermal adjustment units such as freezer or heating packs.

### BACKGROUND OF THE INVENTION

Coolers are commonly used for storing perishable food and beverage items. Coolers are suitable for use in numerous enviromnents, including sporting events, social outings, catering events, and work settings. Coolers provide refrigeration, so that food and beverage items can be stored for an extended period of time period before spoiling.

In certain settings, it is desirable to refrigerate food and beverage items in the cooler to maintain the freshness of these items before they are consumed. Typically, ice is used as a refrigerant for the cooler to keep the temperature in the cooler low. An alternate solution is to forgo ice usage by refrigerating or freezing the food and beverage items before placing them in the cooler. However, this solution requires preparation by refrigerating or freezing the items prior to the time they are to be placed in the cooler. Such preparation time is often unavailable. Also, many items do not freeze well, such as beverages in cans. Therefore, in most cases, ice is the solution for providing refrigeration. One disadvantage of using ice is the residual liquid collected from melted ice that may immerse food and beverage items in the cooler. Melted ice water also introduces problems for disposing of the liquid in a sanitary manner.

A cooler is a box shaped structure defining an inner chamber to hold food and beverage items. The walls of the cooler are insulated to maintain a temperature within the chamber. A cooler includes a handle to lift the cooler. However, the volume of ice required to provide refrigeration adds significant weight to the cooler and makes it more difficult to transport. The insulated walls are impermeable trapping melted ice water. After extended use, the ice providing refrigeration will melt and the food and beverage items are submerged in the water.

### SUMMARY OF THE INVENTION

Embodiments of invention include an insulating apparatus and a process for manufacturing the insulating apparatus. In one embodiment, the insulating apparatus defines a set of internal compartments to hold a set of removable thermal adjustment units. The temperature of the interior of insulating apparatus can be regulated by the set of removable thermal adjustment units. A suitable refrigerant or heating compound is used within the removable thermal adjustment unit to regulate the temperature. A set of removable trays may also be inserted into the insulating apparatus to store beverages or similar items. A lid of the insulating apparatus forms a seal over an opening to the interior of the insulating apparatus. A custom graphic can be applied to the lid and/or the exterior of the insulating apparatus.

### BRIEF DESCRIPTION OF THE DRAWINGS

The present invention is illustrated by way of example and not limitation in the figures of the accompanying drawings in which like references indicate similar elements. It should be noted that references to “an” or “one” embodiment in this disclosure are not necessarily to the same embodiment, and such references mean “at least one.”

FIGS. 1A-C are diagrams of one embodiment of an insulating apparatus, lid, and removable thermal packs.

FIGS. 2A-C are diagrams of one embodiment of an insulating apparatus, lid, and removable tray.

FIGS. 3A-C are diagrams of one embodiment of an insulating apparatus, lid, and removable tray.

FIG. 4 is a diagram of one embodiment of a removable thermal pack.

FIGS. 5s are diagrams of one embodiment of an insulating apparatus with removable thermal packs, lid and removable tray.

FIGS. 6A-C are diagrams of one embodiment of an insulating apparatus, lid, and removable tray.

FIGS. 7A-C are diagrams of one embodiment of an insulating apparatus, lid, and removable tray.

FIG. 8 is a flowchart of one embodiment of a process for manufacturing an insulating apparatus.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, functional, and other changes may be made without departing from the scope of the present invention. The following detailed description is, therefore, not to be taken in a limiting sense, and the scope of the present invention is defined only by the appended claims. It will be apparent to one of ordinary skill in the art that the embodiments may be practiced without some of these specific details. In other instances, certain structures and devices are omitted or simplified to avoid obscuring the details of the various embodiments.

The insulating apparatus including removable thermal adjustment units is described in relation to example embodiments, such as a cooler with removable freezer packs. One skilled in the art would understand that the principles, features and structures of these example embodiments are applicable to other embodiments. Specific examples are utilized for sake of clarity and are not intended to limit the scope of invention. While the embodiment of a cooler with removable freezer packs is primarily discussed, the same principles, techniques and structures can be modified to provide a warming unit that includes removable heat packs. The insulating apparatus in this embodiment is used to maintain a warm or heated storage compartment. The presented cooler embodiment maintains a cool or refrigerated storage compartment. One skilled in the art would understand that these and similar modifications are enabled by the following description.

### Cylindrical Cooler

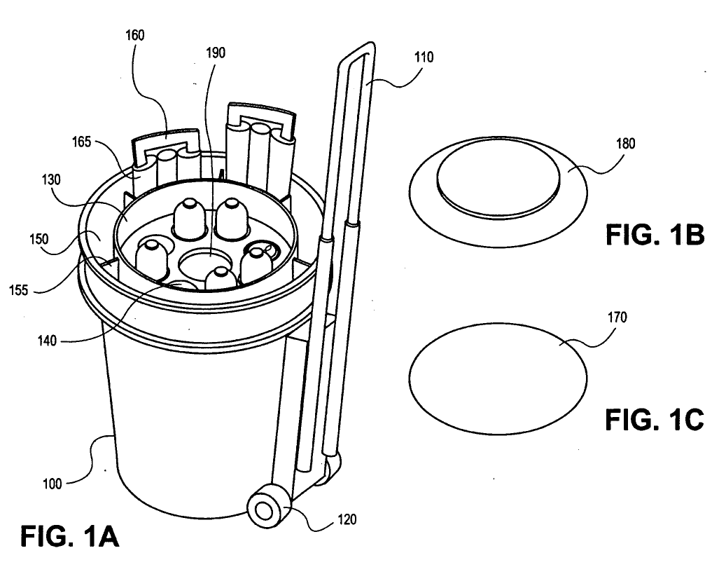

FIG. 1A illustrates one embodiment of a cooler with removable freezer packs. The cooler or similar insulating apparatus includes an outer wall 100 comprised of a side wall and bottom wall that forms the housing or exterior of the cooler. Inner wall 130 defines a set of compartments 150 between outer wall 100 and inner wall 130. A ‘set,’ as used herein, refers to any whole number of items including one item. The inner wall 130 also defines a storage compartment 190. In one embodiment, a set of removable freezer packs 165 or a similar thermal adjustment unit can be inserted into one of the set of compartments between inner wall 130 and outer wall 100. Inner wall 130 and outer wall 100 of the cooler may be formed of materials including, but not limited to, plastics (e.g., polyethylene, polycarbonate, polypropylene, polystyrene, or acrylonitrile butadiene styrene), metals (e.g., aluminum, steel, tin, titanium, or chrome), composite compounds (e.g., carbon fiber or fiberglass), and other resilient and lightweight materials. Materials utilized for inner wall 130 and outer wall 100 may be selected for their insulating properties. The insulating properties of inner wall 130 and outer wall 100 protect storage compartment 190 from temperature and environmental conditions outside of the cooler and allow storage compartment 190 to have a temperature regulated by the set of freezer packs 165. Inner wall 130 and outer wall 100 can be formed by any process including molding, extrusion, welding or similar assembly techniques.

The cooler can have any size or dimensions that can define a compartment to hold items. In one embodiment, the outer diameter of the cooler may range from 0.5′ to 5′ and the height of the cooler may range from 0.5′ to 5′. The dimensions of the storage compartment can range from a diameter of 0.5′ to 4.75′. Any number of compartments 150 can be defined by a set of radial walls 155. The set of compartments can have any size and dimensions suitable for receiving and securing freezer packs 165.

In one embodiment, removable freezer pack 165 may include handle 160 coupled at one end to facilitate removal from and insertion into one of the set of compartments within the cooler. Removable freezer pack 165 refrigerates the storage compartment 190 of the cooler. In one embodiment, tray 140 is disposed within the storage compartment 190 and is removably coupled with inner wall 130 of the cooler. Inner wall 130 forms a lip to support tray 140 and provides a form fit with tray 140 or similarly supports tray 140. In this manner, tray 140 can be disposed in the cooler for storage. Tray 140 defines a set of apertures or recesses for holding beverages, an item with a frusto-conical shape (e.g., a cup) or similarly shaped items. Once the items are placed in tray 140, removable freezer pack 165 provides refrigeration of the items located in tray 140.

In one embodiment, handle 110 and a movement mechanism 120 are attached to outer wall 100 of the cooler to facilitate transportation of the cooler. Handle 110 can have any size or dimensions suitable for managing the movement of the cooler. In one embodiment, handle 110 is a telescoping handle to allow adjustment of the length of handle 110. The transportation mechanism 120 can be a set of wheels, rollers, skis or similar mechanisms to facilitate the movement of the cooler over various surfaces.

FIG. 1B is a diagram of a lid for the cooler or insulating apparatus. In one embodiment, lid 180 is removably coupled to the top of the cooler to form a seal over the storage area and the set of compartments in the cooler. In this manner, the interior temperature of the cooler is further insulated from exterior conditions. Lid 180 can be formed from the same insulating materials as the cooler or other insulating materials. Lid 180 has dimensions that are complementary to the opening of the cooler. Lid 180 can be formed by molding, extrusion, pressing or similar assembly techniques. In other embodiments, lid 180 is coupled to the cooler by a set of hinges, tether or similar mechanism that allows access to the storage compartment without entirely separating lid 180 from the cooler.

FIG. 1C is a diagram of a top freezer pack or circular thermal adjustment unit. In one embodiment, a top freezer pack 170 may be removably coupled with a bottom portion of lid 180 or be similarly fit over the opening of the cooler. In one embodiment, a fastening device such as a screw or nut and bolt may be used for attaching thermal pack 170 to lid 180. In another embodiment, the inner walls, outer walls and radial walls define a space to receive and secure the freezer pack 170. A bottom freezer pack can be placed in a similar fashion at the bottom of the storage compartment of the cooler.

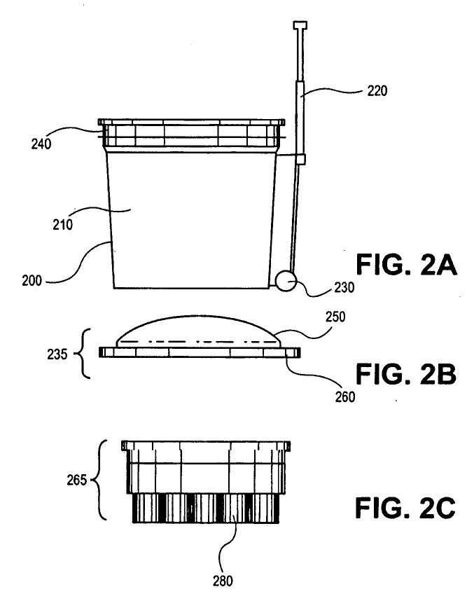

FIGS. 2A-2C illustrate a side view of the cooler. In FIG. 2A, outer wall 210 forms the housing or exterior of cooler 200. Flange 240 may be formed on the exterior of the cooler to increase the strength of the cooler. Handle 220 and wheel 230 may be coupled to outer wall 210 to transport cooler 210. Handle 220 may also be retractable to adjust the length of handle 220.

In FIG. 2B, lid 235 may be attached to form a seal with an open portion of outer wall 210. In one embodiment, lid 235 includes base 260 and padded top 250. The padded to 250 provided cushions that enable the use of the cooler as a seat. The lid 238 in combination with the inner wall and outer wall 210 define a structure that can support 50-250 pounds of weight thereby allowing an adult or child to sit on the cooler without impact to the contents of the cooler. In another embodiment, lid 235 does not include a padded top and is flat on its top surface. The top surface can also be formed with recesses for holding drinks, provide a handle, or include similar structures. Base 260 may include a suitable material, such as rubber ring, bordering the circumference of base 260 to provide a tighter seal (e.g., a water tight seal) between base 260 and the open portion of outer wall 210. In one embodiment, lid 235 includes padding 260. Padding 250 may be constructed from foam or other filling material and covered in upholstery comprised of fabric or leather.

In FIG. 2C, removable tray 265 may include a set of receptacles 280 that form a set of apertures or recesses suitable to receive a beverage or other item with a frusto-conical shape such as a cup. In another embodiment, tray 265 may define receptacles for holding food items and other structures for specific uses such receptacles for bait and tackle for a cooler designed to accompany a fishing trip. In one embodiment, tray 265 may be stored in the cooler in the manner described above in FIG. 1A.

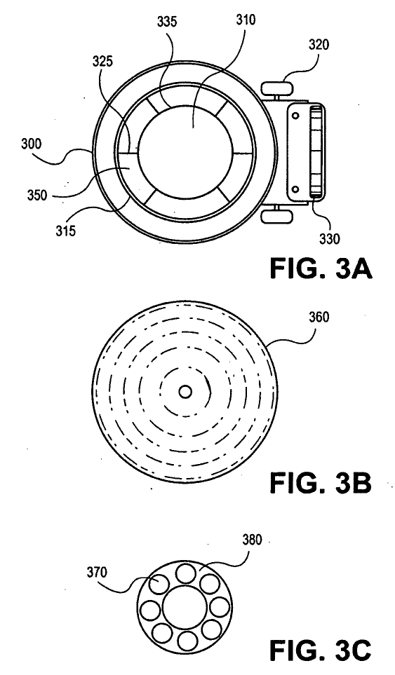

FIGS. 3A-3C illustrates a plan view of the cooler. In FIG. 3A, inner wall 335 and a set of radial walls 325 define a set of compartments 350 between side walls 315 of cooler 300. Inner wall 335 may define a lip to support tray 380 in FIG. 3C over bottom wall 310. Inner wall 335 and side wall 315 provide insulation for maintaining an interior temperature of the cooler. Each of the compartments is suitable for storing a removable thermal adjustment unit (e.g., removable freezer pack or heating pack). Each removable thermal adjustment unit provides refrigeration or heating of the compartments defined by inner wall 335 and radial wall 325. In this manner, the interior of cooler 300 can be refrigerated or heated. In one embodiment, handle 330 and wheel 320 are coupled to the exterior of cooler 300 to facilitate transportation of cooler 300.

In FIG. 3B, lid 360 may be attached to form a seal with an open top portion of cooler 300. The open top portion of cooler 300 may have a diameter in the range of 0.5′ to 3′. To form the seal, lid 360 may be of a similar diameter to that of the diameter of cooler 300.

In FIG. 3C, tray 380 may include a set of receptacles 370 to hold a beverage or other similar item with a frusto-conical shape. In one embodiment, the diameter of tray 380 is smaller than the diameter of cooler 300. Tray 380 is designed to be removably coupled to rest upon the lip defined by inner wall 325 of cooler 300.

### Removable Thermal Adjustment Unit

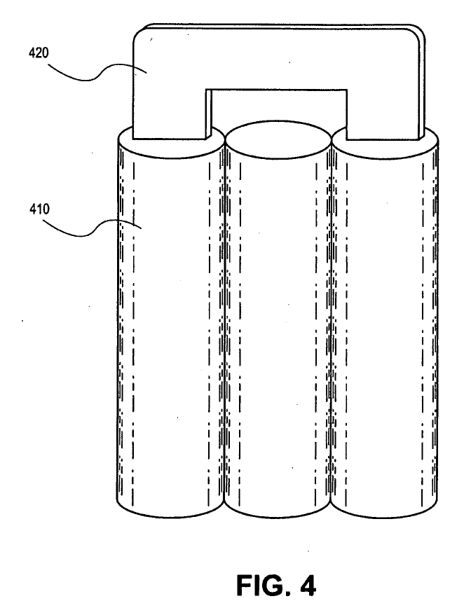

FIG. 4 illustrates of one embodiment of a removable thermal adjustment unit. Thermal adjustment unit may have any dimensions and size suitable for being placed within the interior of the insulating apparatus or cooler. In one embodiment, the dimensions of thermal adjustment unit may be within a length of 3″ to 10″ and a height of 0.5′ to 1.5′. Thermal adjustment unit contains a material suitable for adjusting the temperature of the interior of the cooler. Therefore, the interior temperature of the insulating apparatus or cooler may be better maintained at a lower or higher temperature with thermal adjustment unit than without it. The material for adjusting the temperature inside the cooler may be reusable by either refreezing or heating the material. In one embodiment, thermal adjustment unit may be any dimension and size and formed from any suitable material that is leak-proof and puncture resistant for storing the material for adjusting the temperature of the interior of the cooler. In one embodiment, thermal adjustment unit may be formed from a plastic film (e.g., polyethylene, polypropylene) or metal foil that contains the material for adjusting the temperature inside the cooler. A handle 420 may be attached to one end of thermal adjustment unit to facilitate insertion into the cooler.

In one embodiment, the material used to adjust the interior temperature of the insulating apparatus or cooler is a refrigerant compound with a specific heat higher than that of typical ice (i.e., frozen water). The refrigerant compound may be any material suitable for performing an endothermic reaction that absorbs heat energy. In one embodiment, the refrigerant compound stored in thermal adjustment unit is a non-toxic polymer gel based on a mixture of several compounds such as cornstarch, borax, preservatives, and water. The non-toxic polymer gel is prepared for use by lowering the temperature of the non-toxic polymer gel. In one embodiment, any suitable process for freezing or refrigerating the non-toxic polymer gel is used. In another embodiment, the refrigerant compound is a mixture of polymer crystals and water prepared for use in a similar manner as described above. After thermal adjustment unit is placed within the cooler's interior, thermal adjustment unit lowers the temperature of the cooler's interior during the progression of the endothermic reaction by absorbing heat energy contained within the cooler's interior. In addition, because the refrigerant compound has a higher specific heat than of ice as described above, thermal adjustment unit maintains the lower temperature of the storage compartment inside the cooler for a longer time period than using ice alone because more heat energy is required to transition the refrigerant compound back into a liquid state. In one embodiment, the refrigerant compound may be reused by being refrozen or refrigerated again.

In another embodiment, the material inside of thermal adjustment unit may comprise a heating compound to adjust the interior temperature of the cooler. The heating compound may be any suitable compound used to increase the temperature of the cooler's interior through an exothermic reaction. In one embodiment, thermal adjustment unit is prepared for use by raising the temperature of the heating compound. Any suitable process for raising the temperature of the heating compound may be used. In the case of the sodium acetate solution, the exothermic reaction is performed by nucleation of the solution that causes the sodium acetate to crystallize. In one embodiment, a metal disc contained within thermal adjustment unit may be mixed with the sodium acetate solution to commence the exothermic reaction. During the exothermic reaction, heat energy is released that increases the interior temperature of the cooler. By placing thermal adjustment unit in the cooler's interior, the interior temperature of the cooler may be maintained at a higher temperature than without thermal adjustment unit. In one embodiment, thermal adjustment unit containing the heating compound may be reused by heating thermal adjustment unit to the boiling temperature of water. In the case of the sodium acetate solution, boiling thermal adjustment unit has the effect of dissolving the crystallized sodium acetate back into a liquid state.

### Box Cooler

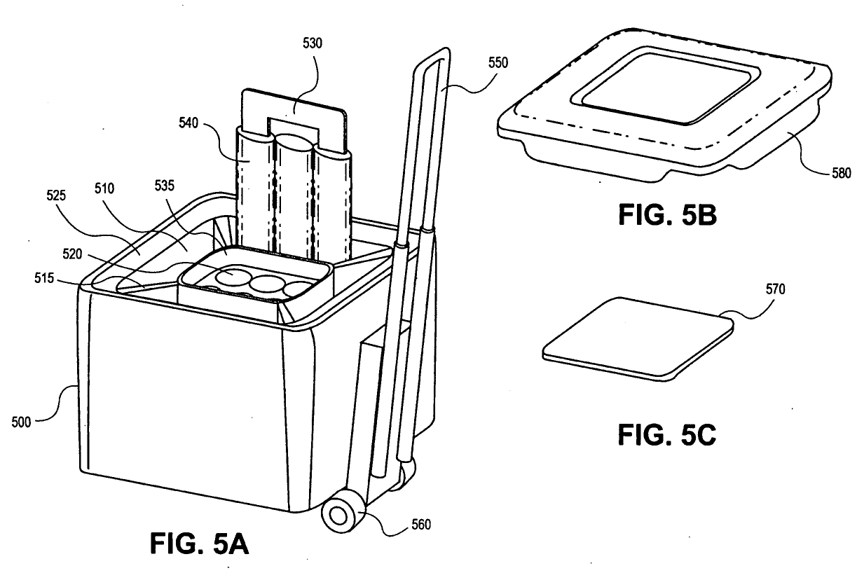

FIG. 5A illustrates another embodiment of a cooler or similar insulating apparatus with a box shape. The cooler or similar insulating apparatus includes an outer wall 500 comprised of a side wall and bottom wall that forms the housing or exterior of the cooler. Inner wall 535 defines a set of compartments 510 between side wall 525 and inner wall 535. Inner wall 535 also defines a storage compartment that tray 520 may be disposed in. Any number of compartments 150 can be defined by a set of diagonal walls 515.

The cooler can have any size or dimensions that can define a storage compartment to hold items. In one embodiment, the length and width of outer wall 500 of the cooler each ranges from 1′ to 5′ and the height of the cooler ranges from 1′ to 4′. The dimensions of the storage compartment can range from a length and width of 0.5′ to 4.75′ and a height from 0.75′ to 4′. The set of compartments can have any size and dimensions suitable for receiving and securing removable freezer packs 540 or other similar removable thermal adjustment units. Inner wall 535 forms a lip to support tray 520 and provides a form fit with tray 520 or similarly supports tray 520. In this manner, tray 520 can be disposed in the cooler for storage and removably coupled with inner wall 535. Tray 520 defines a set of apertures or recesses for holding beverages or an item with a frusto-conical shape (e.g., a cup). Once the items are placed in tray 520, removable freezer pack 540 provides refrigeration of the items located in tray 520.

Outer wall 500, side wall 525, and inner wall 535 may be formed from materials including, but not limited to, plastics (e.g., polyethylene, polycarbonate, polypropylene, polystyrene, or acrylonitrile butadiene styrene), metals (e.g., aluminum, steel, tin, or chrome), composite compounds (e.g., carbon fiber), and other resilient and lightweight materials. Materials may be selected for their insulating properties. The insulating properties of inner wall 525, side wall 525, and outer wall 500 protect the storage compartment from temperature and environmental conditions outside of the cooler. In this manner, the temperature of the storage compartment is regulated by the set of freezer packs 540. In addition, outer wall 500, side wall 525, and inner wall 525 can be formed by any process including molding, extrusion, welding or similar assembly techniques.

In one embodiment, removable freezer pack 540 may include handle 530 coupled at one end to facilitate removal from and insertion into one of the set of compartments within the cooler. Removable freezer pack 540 refrigerates the storage compartment of the cooler.

In one embodiment, handle 550 and a movement mechanism 560 are attached to outer wall 500 of the cooler to facilitate transportation of the cooler. Handle 550 can have any size or dimensions suitable for managing the movement of the cooler. In one embodiment, handle 550 is a telescoping handle to allow adjustment of the length of handle 550. The transportation mechanism 560 can be a set of wheels, rollers, skis or similar mechanisms to facilitate the movement of the cooler over various surfaces.

FIG. 5B is a diagram of a lid for the cooler or insulating apparatus with the box shape. In one embodiment, lid 580 is removably coupled to the top of the cooler to form a seal over the storage area and the set of compartments in the cooler. In this manner, the interior temperature of the cooler is further insulated from exterior conditions. Lid 580 can be formed from the same insulating materials as the cooler or other insulating materials. Lid 580 has dimensions that are complementary to the opening of the cooler. Lid 580 can be formed by molding, extrusion, pressing or similar assembly techniques. In other embodiments, lid 580 is coupled to the cooler by a set of hinges, tether or similar mechanism that allows access to the storage compartment without entirely separating lid 580 from the cooler.

FIG. 5C is a diagram of a top freezer pack. In one embodiment, a top freezer pack 570 or similar removable thermal adjustment unit may be removably coupled with a bottom portion of lid 580 or be similarly fit over the opening of the cooler. In one embodiment, a fastening device such as a screw or nut may be used for attaching thermal pack 570 to lid 580. In another embodiment, the inner walls, outer walls and diagonal walls define a space to receive and secure the freezer pack 570. A bottom freezer pack can be placed in a similar fashion at the bottom of the storage compartment of the cooler.

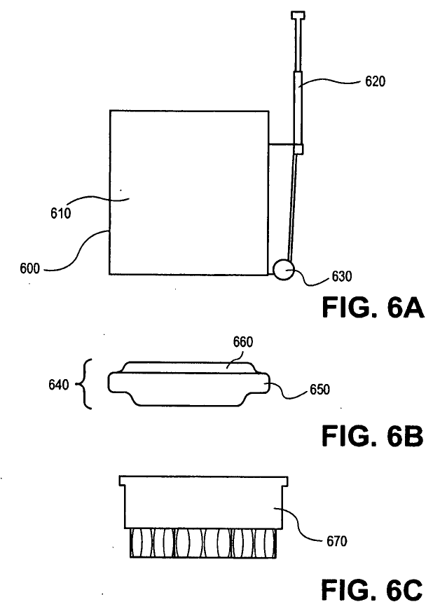

FIGS. 6A-6C illustrates a side view of the cooler with the box shape. In FIG. 6A, outer wall 610 forms the housing or exterior of cooler 600. Handle 620 and wheel 630 is coupled to outer wall 610 to transport cooler 610. Handle 620 also may be retractable to adjust the length of handle 620.

In FIG. 6B, lid 640 may be attached to form a seal with an open portion of outer wall 210. In one embodiment, lid 640 includes base 650 and padded top 660. The padded top 660 provide cushions allowing the cooler to be used as a seat or stool. The material and design of the inner and outer walls can provide structural support for the use of the cooler as a seat for any size or weight of individual. In another embodiment, lid 640 does not include a padded top and is flat on its top surface. The top surface can also be formed with recesses for holding drinks, provide a handle, or include similar structures. Base 650 may include a suitable material, such as rubber ring, bordering the circumference of base 650 to provide a tighter seal (e.g., a water tight seal) between base 650 and the open portion of the cooler. In one embodiment, lid 640 includes padding 650. Padding 660 may be constructed from foam or other filling material and covered in upholstery comprised of fabric or leather.

In FIG. 6C, removable tray 670 may include a set of receptacles that form a set of apertures or recesses suitable to receive a beverage or other item with a frusto-conical shape such as a cup. In one embodiment, removable tray 670 may be stored in the cooler in the manner described above in FIG. 5A.

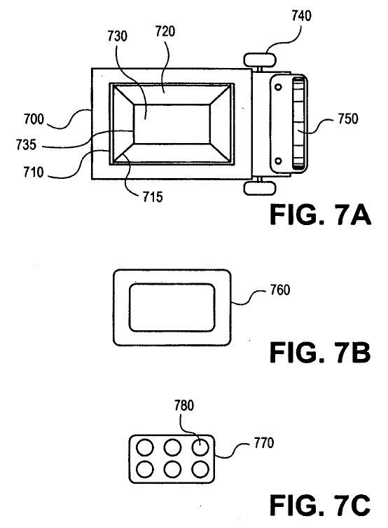

FIGS. 7A-7C illustrates a plan view of the cooler. In FIG. 7A, a storage compartment defined by inner wall 735 and bottom wall 730 is suitable for storing items in cooler 700. Inner wall 735 defines a set of compartments 720 between side wall 710 and inner wall 735. Inner wall 710 also defines a lip to support tray 770 shown in FIG. 7C. Inner wall 735 and side wall 710 provide insulation for maintaining an interior temperature of the cooler. Each of the compartments 720 is suitable for storing a removable thermal adjustment unit (e.g., removable freezer pack or heater pack). Each removable thermal adjustment unit can provide refrigeration or heating of the compartments defined by inner wall 735 and a set of diagonal walls 715. In this manner, the interior of cooler 700 can be refrigerated or heated. In one embodiment, handle 750 and a set of wheels 740 are coupled to cooler 700 to facilitate transportation of cooler 700.

In FIG. 7B, lid 760 may be attached to form a seal with an open top portion of cooler 700. The open top portion of cooler 700 may have a length and width in the range of 1′ to 5′. To form the seal, lid 760 may be of a similar length and width to that of cooler 700.

In FIG. 7C, tray 770 may include a set of receptacles 780 to hold a beverage or other similar item with a frusto-conical shape. In one embodiment, the length and width of tray 770 is smaller than the corresponding dimensions of cooler 700. Tray 770 is designed to be removably coupled to rest upon the lip defined by inner wall 735 of cooler 700.

### Manufacturing the Insulating Apparatus

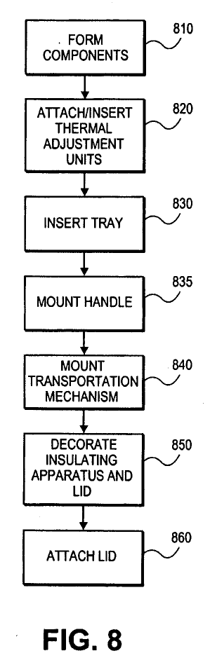

FIG. 8 illustrates one embodiment of a process for manufacturing the insulating apparatus. The components of the insulating apparatus are produced using a suitable manufacturing technique such as injection molding, thermoforming, blow molding, rotational molding, vibration welding, or structural foam molding (block 810). The foregoing manufacturing techniques are illustrative and those skilled in the art would appreciate that alternative techniques may be used in manufacturing the insulating apparatus. The components of the insulating apparatus may be constructed from materials comprising plastics, fiber composites (e.g., carbon fiber, Texalium, Kevlar, or fiberglass), metals (e.g., aluminum, tin, steel, chrome, or titanium), or any other suitable lightweight and resilient material. The components such as the outer, inner and compartment walls may be formed as a single integrated component or may be formed separately and assembled. Other components include the lid, transportation mechanism, tray, handles, thermal adjustment units and similar components are each formed separately and may be assembled from sub-components.

The thermal adjustment units are then inserted or attached to their respective placements within the insulating apparatus (block 820). A set of thermal adjustment units is placed in the set of compartments between the inner and outer walls of the insulating apparatus. In one embodiment, a bottom thermal adjustment unit is placed or attached to the bottom of the storage compartment. A top thermal adjustment unit is attached to the lid. Any securing mechanisms such as screws, brackets or similar mechanisms can be used to secure the top and bottom thermal adjustment units. In another embodiment, the top and/or bottom thermal adjustment units are omitted from the insulating apparatus.

The tray is inserted into the insulating apparatus (block 830). In one embodiment, the tray is form fitted to be rest upon on a lip defined by the inner wall of the insulating apparatus. In another embodiment, the tray includes a set of latches, fasteners, clips, or similar mechanism for securing the tray to the inner wall of the insulating apparatus.

The handle is then mounted to the outer wall of the insulating apparatus (block 835). Any suitable securing mechanism including screws, brackets, fasteners, or similar mechanisms can be used to secure the handle to the insulating apparatus. The handle can be mounted in any suitable position on the outer wall of the insulating apparatus. In one embodiment, the handle can be mounted at a position distal to a bottom wall of the insulating apparatus.

Next, the transportation mechanism is mounted to the outer wall of the insulating apparatus (block 840). The transportation mechanism can be a set of wheels, skis, rollers, ball bearings, or similar mechanisms to facilitate the movement of the cooler over various surfaces. In one embodiment, the transportation mechanism is mounted at a position distal to the handle.

The insulating apparatus and lid are then decorated (block 850). In one embodiment, a graphic is applied to the outer wall of the insulating apparatus and top portion of the lid using a silk screening process, adhesive decal, or other similar printing technique. The top portion of the lid may include padding covered in upholstery that can be decorated using embroidery, cloth patching, pattern dying, staining, or other suitable upholstery decorating technique. In another embodiment, decoration on the insulating apparatus and lid are omitted.

Finally, the lid is attached to an open portion of the insulating apparatus. Any suitable mechanism such as a flange, fastener, rubber ring, latch, clip, or similar mechanism may be used to attach the lid to the insulating apparatus. In one embodiment, the lid includes a rubber ring or similar mechanism to form an air tight or water tight seal with the insulating mechanism.

The embodiments of the present invention have been described largely by reference to specific examples illustrated in the figures and described above. However, those of skill in the art will appreciate that alternatives and modifications of the embodiments of this invention will become apparent to those skilled in the art without departing from the scope of this invention. Such variations and implementations are understood to be captured according to the following claims.

What is claimed is:

1. An insulating apparatus comprising:
a housing defining an outer wall including a side wall and a bottom wall, an inner wall and a plurality of compartments between the inner wall and outer wall, the inner wall defining a storage compartment; and
a thermal adjustment unit removably coupled to the housing, the thermal adjustment unit to fit within one of the plurality of compartments and to adjust a temperature of the storage compartment.

2. The insulating apparatus of claim 1 further comprising:
a removable tray disposed in the storage compartment, the removable tray defining a plurality of receptacles.

3. The insulating apparatus of claim 2, wherein each of the plurality of receptacles defines an aperture to receive an item.

4. The insulating apparatus of claim 3, wherein the item has a frusto-conical shape.

5. The insulating apparatus of claim 1, wherein the thermal adjustment unit increases or decreases a temperature of the storage compartment.

6. The insulating apparatus of claim 1, wherein the thermal adjustment unit comprises a removable pack, the removable pack containing a material suitable for adjusting a temperature of the storage compartment.

7. The insulating apparatus of claim 5, wherein the removable pack includes a handle coupled to an end of the removable pack.

8. The insulating apparatus of claim 7, wherein the removable pack includes a refrigerant compound or heating compound suitable to adjusting the temperature of the storage compartment.

9. The insulating apparatus of claim 8, wherein the removable pack is reusable.

10. The insulating apparatus of claim 1, further comprising:
a handle and set of wheels coupled to the housing.

11. The insulating apparatus of claim 10, wherein the handle is adjustable in length.

12. The insulating apparatus of claim 1, further comprising:
a lid, the lid to form a seal with an open end of the housing.

13. The insulating apparatus of claim 12, wherein the lid includes a flange to facilitate forming the seal with the open end of the housing.

14. The insulating apparatus of claim 1, further comprising:
a thermal adjustment unit inserted within the storage compartment.

15. The insulating apparatus of claim 14, wherein the thermal adjustment unit comprises a removable freezer pack, the removable freezer pack containing a material suitable to provide refrigeration of the storage compartment.

16. A method comprising:
forming components of an insulating apparatus;
attaching thermal adjustment unit inside the insulating apparatus;
inserting a tray in the insulating apparatus;
mounting a handle to the insulating apparatus;
mounting a transportation mechanism to the insulating apparatus; and
attaching a lid the insulating apparatus.

17. The method of claim 16, further comprising:
attaching a removable thermal adjustment unit to the lid.

18. The method of claim 16, further comprising:
decorating the insulating apparatus and the lid.

19. The method of claim 16, wherein decorating comprises:
applying a graphic to the insulating apparatus and the lid.

20. The method of claim 19, wherein applying the graphic comprises a silk-screening technique.
